(19) United States
(12) Patent Application Publication
(10) Pub. No.: US 2026/0366997 A1
(43) Pub. Date: Nov. 19, 2026

(54) OPTICAL FREQUENCY COMB BASED TERAHERTZ SPECTROMETER AND METHOD OF THICKNESS MEASUREMENT USING THE SAME

(71) Applicant: KOREA ADVANCED INSTITUTE OF SCIENCE AND TECHNOLOGY, Daejeon (KR)

(72) Inventors: Young-Jin KIM, Daejeon (KR); Guseon KANG, Daejeon (KR); Jaeyoon KIM, Daejeon (KR)

(21) Appl. No.: 19/550,505

(22) Filed: Feb. 26, 2026

(30) Foreign Application Priority Data
Feb. 27, 2025 (KR) 10-2025-0025546
Feb. 25, 2026 (KR) 10-2026-0034881

(51) Int. Cl. G01N 21/3581; G01B 11/06; G01J 3/26; G01J 3/433

(52) U.S. Cl. CPC G01N 21/3581; G01B 11/06; G01J 3/26; G01J 3/433; G01J 2003/4332

(57) ABSTRACT

A terahertz spectrometer comprises: a comb line extractor configured to extract a comb line from an optical frequency comb and output a frequency-fixed optical signal; a frequency-swept laser configured to output a frequency-swept optical signal that is frequency-calibrated based on the optical frequency comb; a terahertz emitting-photomixer configured to generate a frequency-sweeping terahertz signal by photomixing the frequency-swept optical signal with the frequency-fixed optical signal modulated with a heterodyne frequency, and to emit the terahertz signal to a measurement target; a terahertz receiving-photomixer configured to receive the terahertz signal transmitted from the measurement target and to mix an optical beat signal with the received terahertz signal, the optical beat signal generated by combination of the frequency-fixed optical signal and the frequency-swept optical signal; and a thickness measurement module configured to generate a terahertz spectrum from an output of the terahertz receiving-photomixer, analyze the terahertz spectrum to determine an absolute frequency of a Fabry-Pérot mode, and calculate a thickness from the absolute frequency.

### CROSS-REFERENCE TO RELATED APPLICATION

This application claims priority to and the benefit of Korean Patent Application No. 10-2025-0025546 filed with the Korean Intellectual Property Office on Feb. 27, 2025, and Korean Patent Application No. 10-2026-0034881 filed with the Korean Intellectual Property Office on Feb. 25, 2026, entire contents of which are incorporated herein by reference.

### BACKGROUND

### (a) Field

The present invention relates to a method for measuring a thickness of a measurement target such as a wafer.

### (b) Description of the Related Art

Wafer thinning is an essential process in advanced semiconductor packaging to meet the critical requirements of high-bandwidth memory (HBM) and three-dimensional integrated circuits. This process includes back-grinding, dry etching, wet etching, and chemical mechanical polishing (CMP) processes, enabling the production of ultra-thin wafers. Precise control over the wafer's smoothness, thickness, and flatness is critical to ensuring the structural reliability and performance of interconnect structures. CMP is a key process that simultaneously achieves wafer planarization and thinning. It utilizes nanoscale abrasives to remove residual scratches from grinding or etching while achieving the target thickness. However, since the surface roughness and thickness vary simultaneously during the CMP process, fast and reliable monitoring of these properties is necessary for process optimization.

Conventional visible-light-based optical measurement methods have a limitation in that measurement accuracy is degraded due to low optical transmittance and strong light scattering. Near-infrared-based measurement methods are also vulnerable to surface scattering, making it difficult to maintain thickness precision beyond a certain level. Accordingly, new thickness measurement technologies that utilize longer wavelengths to enhance transmittance and minimize scattering are required.

Meanwhile, there have been attempts to overcome the limitations of conventional thickness measurement methods using long-wavelength terahertz light sources. However, conventional non-destructive testing systems, including terahertz time-domain spectroscopy (TDS) and frequency-domain spectroscopy (FDS), are limited in their performance by frequency uncertainty of THz sources, restricting their thickness precision to a few or tens of micrometer levels. To achieve nanometer-level precision, a more stable terahertz light source is required.

### SUMMARY

This disclosure provides an optical frequency comb-based terahertz spectrometer and a method of thickness measurement using the same.

This disclosure provides a method for measuring the thickness of a measurement target by measuring the absolute frequency of Fabry-Pérot (FP) mode caused by transmission and reflection of terahertz signals in the measurement target.

Some embodiments of the present disclosure provide a terahertz spectrometer including: a comb line extractor configured to extract a comb line from an optical frequency comb and output a frequency-fixed optical signal; a frequency-swept laser configured to output a frequency-swept optical signal that is frequency-calibrated based on the optical frequency comb; a terahertz emitting-photomixer configured to generate a frequency-sweeping terahertz signal by photomixing the frequency-swept optical signal with the frequency-fixed optical signal modulated with a heterodyne frequency, and to emit the terahertz signal to a measurement target; a terahertz receiving-photomixer configured to receive the terahertz signal transmitted from the measurement target and to mix an optical beat signal with the received terahertz signal, the optical beat signal generated by combination of the frequency-fixed optical signal and the frequency-swept optical signal; and a thickness measurement module configured to generate a terahertz spectrum from an output of the terahertz receiving-photomixer, analyze the terahertz spectrum to determine an absolute frequency of a Fabry-Pérot mode, and calculate a thickness from the absolute frequency.

A nonlinear sweep rate of the optical signal output from the frequency-swept laser may be calibrated through interference with the optical frequency comb.

The optical frequency comb may be stabilized by being locked to a frequency reference source.

The terahertz spectrum may include Fabry-Pérot modes having a form of a peak or a dip at specific frequencies.

The terahertz spectrometer may further include an acousto-optic modulator configured to perform modulation to frequency-shift the frequency-fixed optical signal output from the comb line extractor by the heterodyne frequency.

The terahertz receiving-photomixer may be configured to output a signal corresponding to the heterodyne frequency by mixing the optical beat signal with the received terahertz signal.

The thickness measurement module may include: a transimpedance amplifier configured to amplify the output of the terahertz receiving-photomixer into a voltage signal and output the voltage signal; a lock-in amplifier configured to extract and amplify a component identical to the heterodyne frequency from the output of the transimpedance amplifier; a data acquisition device configured to generate the terahertz spectrum representing a transmission amplitude or a reflection amplitude according to the terahertz frequency by sampling an output of the lock-in amplifier and mapping the sampled output to a corresponding terahertz frequency; and a computing device configured to analyze the terahertz spectrum to determine the absolute frequency and calculate the thickness from the absolute frequency.

The computing device may be configured to determine the absolute frequency of a corresponding Fabry-Pérot mode by applying spectrum fitting to measurement data around the Fabry-Pérot mode in the terahertz spectrum.

Some embodiments of the present disclosure provide a terahertz spectrometer including: a first photomixer configured to generate a frequency-sweeping terahertz signal through photomixing of a frequency-fixed optical signal generated based on an optical frequency comb and a frequency-swept optical signal that is frequency-calibrated based on the optical frequency comb, and to emit the terahertz signal to a measurement target; a second photomixer configured to receive the terahertz signal transmitted from the measurement target and to mix an optical beat signal with the received terahertz signal; and a thickness measurement module configured to generate a terahertz spectrum from an output of the second photomixer, analyze the terahertz spectrum to determine an absolute frequency of a Fabry-Pérot mode, and calculate a thickness from the absolute frequency.

The frequency-fixed optical signal may be optically combined with the frequency-swept optical signal after being modulated with a heterodyne frequency for terahertz signal generation, and the optical beat signal may be generated by optical combination of the frequency-fixed optical signal and the frequency-swept optical signal.

The thickness measurement module may include: a transimpedance amplifier configured to amplify the output of the second photomixer into a voltage signal and output the voltage signal; a lock-in amplifier configured to extract and amplify a component identical to the heterodyne frequency from an output of the transimpedance amplifier; a data acquisition device configured to generate the terahertz spectrum representing a transmission amplitude or a reflection amplitude according to the terahertz frequency by sampling an output of the lock-in amplifier and mapping the sampled output to a corresponding terahertz frequency; and a computing device configured to analyze the terahertz spectrum to determine the absolute frequency and calculate the thickness from the absolute frequency.

The computing device may be configured to determine the absolute frequency of a corresponding Fabry-Pérot mode by applying spectrum fitting to measurement data around the Fabry-Pérot mode in the terahertz spectrum.

A nonlinear sweep rate of the frequency-swept optical signal may be calibrated through interference with the optical frequency comb.

The optical frequency comb may be stabilized by being locked to a frequency reference source.

The terahertz spectrum may include Fabry-Pérot modes having a form of a peak or a dip at specific frequencies.

Some embodiments of the present disclosure provide a thickness measurement method of an optical frequency comb-based terahertz spectrometer, including: generating a frequency-sweeping terahertz signal using a first frequency-fixed optical signal generated based on an optical frequency comb and a frequency-swept optical signal frequency-calibrated based on the optical frequency comb; emitting the terahertz signal to a measurement target and receiving the terahertz signal transmitted from the measurement target; generating a terahertz spectrum comprising Fabry-Pérot modes having a form of a peak or a dip at specific frequencies based on the received terahertz signal; and analyzing the terahertz spectrum to determine an absolute frequency of at least one Fabry-Pérot mode of interest, and calculating a thickness from the absolute frequency.

The generating the frequency-sweeping terahertz signal may include: generating the first frequency-fixed optical signal from the optical frequency comb stabilized to a frequency reference source; outputting the frequency-swept optical signal whose frequency sweep rate is calibrated based on the optical frequency comb; modulating the first frequency-fixed optical signal into a second frequency-fixed optical signal with a specific heterodyne frequency; and generating the frequency-sweeping terahertz signal by photomixing the second frequency-fixed optical signal and the frequency-swept optical signal.

The generating the terahertz spectrum may include: detecting a heterodyne frequency signal by mixing a beat signal between the first frequency-fixed optical signal and the frequency-swept optical signal with the received terahertz signal; and generating the terahertz spectrum representing a transmission amplitude spectrum or a reflection amplitude spectrum according to the terahertz frequency by sampling the heterodyne frequency signal.

The calculating the thickness may include: determining the absolute frequency of a corresponding Fabry-Pérot mode by applying spectrum fitting to measurement data around the Fabry-Pérot mode in the terahertz spectrum; and calculating the thickness of the measurement target from the absolute frequency based on a relationship between a frequency of a Fabry-Pérot mode and thickness.

The optical frequency comb may be stabilized by being locked to a frequency reference source, and a nonlinear sweep rate of the frequency-swept optical signal may be calibrated through interference with the optical frequency comb.

According to the present disclosure, the limitations of conventional thickness measurement methods may be overcome by utilizing terahertz frequencies that offer superior transmittance of wafers compared to visible light and near-infrared light and minimize scattering effects caused by surface roughness.

According to the present disclosure, the precision of semiconductor wafer thickness measurement may be improved to the nanometer level, thickness measurements may be performed reliably regardless of surface conditions such as surface roughness, and measurements can be completed quickly within several seconds.

According to the present disclosure, by directly measuring an absolute frequency of the Fabry-Pérot mode caused by Fabry-Pérot interference, measurement accuracy may be improved while ensuring frequency stability. Furthermore, by eliminating a necessity for interference fringes analysis across a broadband spectrum, faster measurements may be performed in a narrower spectral range.

According to the present disclosure, a fixed frequency may be obtained by extracting a comb line from an optical frequency comb locked to a frequency standard, and an absolutely calibrated optical frequency may be generated through the optical frequency comb-based sweep frequency calibration, thereby enabling the generation of a stable terahertz frequency.

According to the present disclosure, the reliability and performance of semiconductor processes may be ensured through real-time thickness measurement.

The present disclosure may be utilized for implementing an in-line monitoring and control platform for end-point detection, early defect detection, and process optimization during the silicon wafer thinning process.

The present disclosure may be applied to various semiconductor processes such as TSV (Through-Silicon Via) formation, nanomaterial stacking, and thin-film transistor fabrication, to monitor wafer thickness in real-time. Accordingly, the reliability of semiconductor manufacturing processes may be increased by maintaining optimal process conditions and improving product quality. The present disclosure may be utilized as a core technology for next-generation semiconductor manufacturing processes.

### BRIEF DESCRIPTION OF THE DRAWINGS

FIG. 1 is a diagram conceptually illustrating thickness measurement using an optical frequency comb-based terahertz spectrometer according to an embodiment.

FIG. 2 is a block diagram of an optical frequency comb-based terahertz spectrometer according to an embodiment.

FIG. 3 is a diagram exemplarily illustrating a receiver setting for thickness measurement using a reflection spectrum according to an embodiment.

FIG. 4 is a result of comparing transmission amplitude spectra that vary according to presence or absence of optical frequency comb-based frequency calibration.

FIG. 5 is an example of a transmission amplitude spectrum according to an embodiment.

FIG. 6 is a diagram showing a dispersion of a specific Fabry-Pérot mode and a histogram of an extracted thickness according to an embodiment.

FIG. 7 is a diagram showing an Allan deviation of a measured thickness according to an embodiment.

FIG. 8 is a diagram explaining a thickness measurement result not affected by surface roughness according to an embodiment.

FIG. 9 is a diagram comparing measurement results of the present disclosure and a visible light laser-based Michelson interferometer.

FIG. 10 is a flowchart of a thickness measurement method according to an embodiment.

### DETAILED DESCRIPTION OF THE EMBODIMENTS

The following description provides a detailed explanation of an embodiment of the present disclosure, with reference to the attached drawings, so that a person skilled in the art to which the present disclosure pertains may readily practice it. However, the present disclosure may be embodied in various different forms and is not limited to the embodiments described herein. Furthermore, to clearly illustrate the present disclosure in the drawings, parts unrelated to the description have been omitted, and similar parts throughout the specification have been assigned similar reference numerals.

Unless explicitly described to the contrary, the word “comprise”, and variations such as “comprises” or “comprising”, will be understood to imply the inclusion of stated elements but not the exclusion of any other elements.

In the description, the reference numbers and names are provided for the convenience of the description, but the present disclosure is not limited thereto.

Next, a terahertz spectrometer capable of non-destructive thickness measurements with nanometer precision by using high accuracy and stability of an optical frequency comb and scattering insensitivity and deep transmittance of terahertz signals will be described.

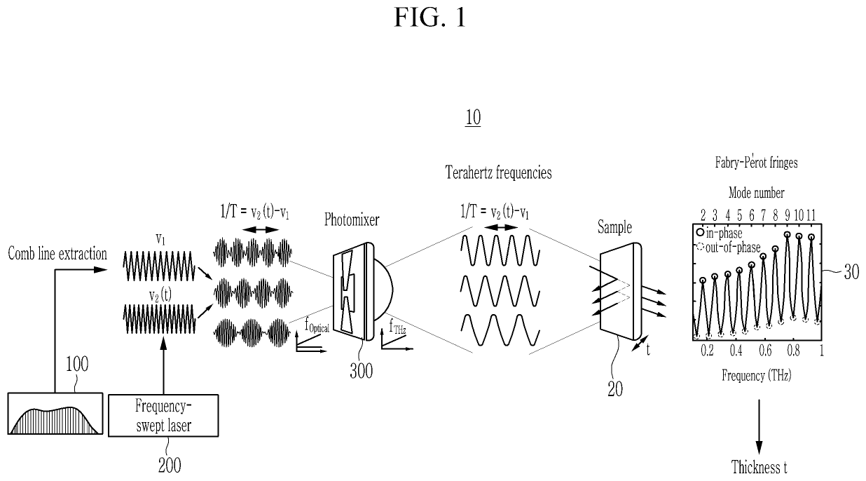

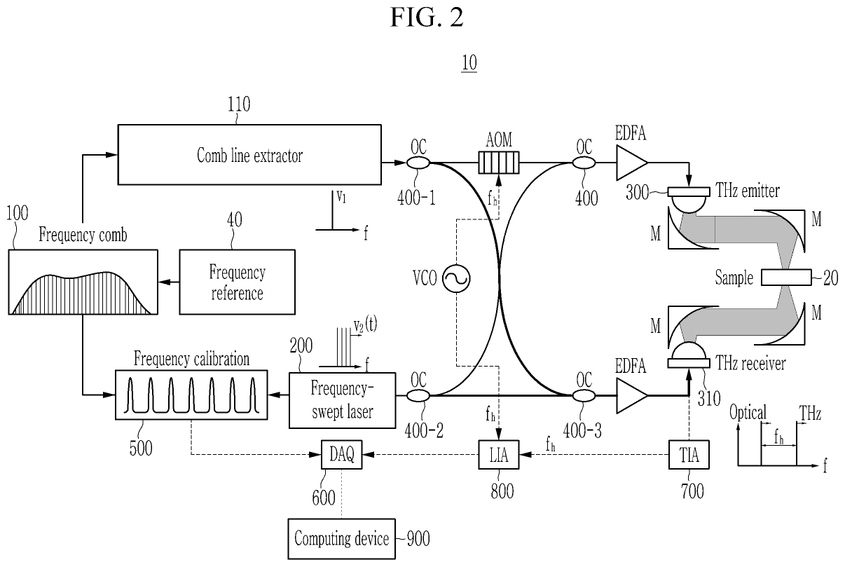

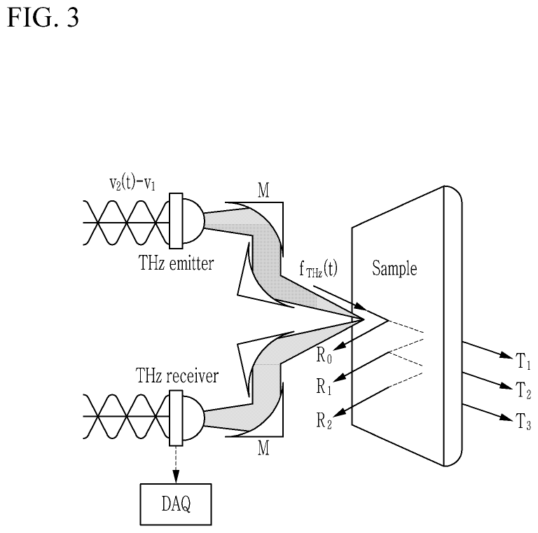

FIG. 1 is a diagram conceptually illustrating thickness measurement using an optical frequency comb-based terahertz spectrometer according to an embodiment, FIG. 2 is a block diagram of an optical frequency comb-based terahertz spectrometer according to an embodiment, FIG. 3 is a diagram exemplarily illustrating a receiver setting for thickness measurement using a reflection spectrum according to an embodiment.

Referring to FIG. 1, an optical frequency comb-based terahertz spectrometer (hereinafter referred to simply as a “terahertz spectrometer”) 10 is configured to generate a frequency-sweeping terahertz signal through optical-to-THz down-conversion and to emit the terahertz signal toward a measurement target (sample) 20. Fabry-Pérot interference occurs in the measurement target 20 due to transmission and reflection of the terahertz signal. An absolute frequency of a Fabry-Pérot (FP) mode is measured, and a thickness of the measurement target may be calculated through a frequency-thickness conversion equation. Here, the terahertz spectrometer 10 ensures long-term stability of the absolute frequency by performing frequency calibration using an optical frequency comb locked to a frequency reference source such as an atomic clock, which will be described in detail with reference to FIG. 2.

The terahertz frequency is a frequency of an optical beat signal generated by combining two optical signals, and may be defined as a difference [v₂(t)−v₁] between a fixed frequency v₁ and a swept frequency v₂(t) that sweeps over a certain range over time. The difference between these optical frequencies may be referred to as a beatnote.

The fixed frequency v₁ may be a frequency of a comb line extracted from an optical frequency comb. A source laser outputting the optical frequency comb may be implemented as a femtosecond pulsed laser, a micro-comb laser, or the like, and is referred to as a femtosecond laser 100 in the description.

The sweep frequency v₂(t) may be provided by a frequency-swept laser 200. The frequency-swept laser 200 is implemented to sweep (scan) a certain range of frequencies/wavelengths at a very high speed, and for example, may be configured to sweep a wavelength band from 1564 nm to 1540 nm to generate a terahertz frequency of a desired band. A beatnote of the fixed frequency v₁ and the sweep frequency v₂(t) is converted into a terahertz frequency. Since the fixed frequency v₁ is extracted from an optical frequency comb locked to a frequency reference source such as an atomic clock, it is an accurate and stable frequency. Accordingly, by calibrating the sweep frequency through interference between the output of the frequency-swept laser 200 and the optical frequency comb, precise time-to-frequency conversion for absolute optical frequency determination may be enabled.

The optical beat signal can be converted into a terahertz signal through optical mixing in a photomixer 300. The terahertz signal is transmitted to a measurement target 20 such as a wafer, and Fabry-Pérot fringes are generated by multiple internal reflections in the measurement target 20. The terahertz spectrometer 10 may measure a thickness t of the measurement target by measuring an absolute frequency of the Fabry-Pérot (FP) mode.

Conventionally, thickness measurement methods using FP interferometers are known, but a free spectral range (FSR) based thickness measurement method that determines a thickness t by analyzing the FSR is common. The FSR is defined as f_{FSR}=c/(2nt), where c is the speed of light and n is a refractive index. The FSR provides an optical path length A, and when the refractive index n is known, the thickness t may be measured using the relationship Λ=n*t. Since the FSR-based thickness measurement method increases the number of FP modes to improve thickness resolution, a broadband spectrum is required. Another known approach involves measuring thickness by analyzing a slope of phase variations in an interference phase, which requires a broadband spectrum to account for nonlinear variations. However, in the terahertz band, there is a limitation in that broadband measurements (e.g., 4 THz or higher) with a high signal-to-noise ratio (SNR) take a long time due to low optical-to-terahertz conversion efficiency in the high-frequency region.

Unlike such conventional thickness measurement methods, since the present disclosure utilizes FP interference caused by a terahertz signal, a thickness is calculated using an absolute frequency of the FP mode measured in a narrow spectral range without a necessity for analyzing interference fringes over a broadband spectrum.

The absolute frequency fₘ of the FP mode is defined as in Equation 1, where m is the FP mode number, c is a speed of light, n is a refractive index, and t is a thickness of a measurement target.

$${f}_{m} = m \times {f}_{FSR} = \frac{mc}{2 nt} \qquad ( Equation 1 )$$

Referring to a transmission amplitude spectrum 30 of FP interference, an FP mode number m is defined as m=q for constructive interference (in-phase) and m=q+0.5 for destructive interference (out-of-phase), where q is an integer.

Using Equation 1, the thickness t may be calculated directly as in Equation 2 by measuring the absolute frequency fₘ of the FP mode corresponding to a selected integer q.

$$t = \frac{mc}{2 n * {f}_{m}} \qquad ( Equation 2 )$$

Unlike conventional FSR-based thickness measurement methods, since the present disclosure calculates a thickness by converting the absolute frequency of the FP mode, high spectral resolution and stability are required even in a narrow spectral range to ensure high-precision thickness measurement. To achieve this, the present disclosure may precisely set a desired terahertz frequency by defining an optical frequency using an optical frequency comb, and may generate an accurate and stable terahertz frequency through optical frequency comb-based frequency calibration.

Referring to FIG. 2, the terahertz spectrometer 10 comprises a femtosecond laser 100 outputting an optical frequency comb, a comb line extractor 110, an acousto-optic modulator (AOM) 120, a frequency-swept laser 200, an optical coupler (OC) 400, and a terahertz emitting-photomixer 300. A terahertz signal may be generated and emitted through these components. Since the comb line extractor 110 outputs an optical signal with a fixed frequency, it may be referred to as a frequency-fixed laser.

A frequency-fixed optical signal extracted from the comb line extractor 110 and a frequency-swept optical signal output from the frequency-swept laser 200 are implemented to be optically coupled by the optical coupler (OC) 400 and incident on the terahertz emitting-photomixer 300. At this time, an optical beat signal generated by the optical coupling may be amplified by an Erbium-doped Fiber Amplifier (EDFA) and then be incident into the terahertz emitting-photomixer 300.

The terahertz spectrometer 10 may further comprise a frequency calibration 500 for nonlinear sweep rate calibration of the frequency-swept laser 200. The frequency calibration 500 is configured to perform frequency calibration by interfering on output of the frequency-swept laser with an optical frequency comb acting as a precise wavelength meter, and the configuration therefore may be implemented in various forms. The frequency calibration 500 generates an optical beat signal from the optical frequency comb and the frequency-swept optical signal output by the frequency-swept laser 200, and the frequency-swept laser 200 may be calibrated by the beat signal data acquired in the DAQ 600. Control of the frequency-swept laser 200 for frequency calibration may be performed by the DAQ 600 or a computing device linked to the DAQ 600.

The terahertz spectrometer 10 may comprise a terahertz receiving-photomixer 310 configured to receive a terahertz signal that has passed through a measurement target 20 or reflected from the measurement target 20, and perform photomixing with an input optical beat signal. The terahertz spectrometer 10 may comprise a thickness measurement module configured to measure a terahertz spectrum using the output of the terahertz receiving-photomixer 310 and calculate the thickness based on this. The thickness measurement module may comprise, for example, a transimpedance amplifier (TIA) 700, a lock-in amplifier (LIA) 800, the DAQ 600, and a computing device 900 for calculating thickness. Optical couplers 400-1, 400-2, 400-3 constituting optical paths for transmitting the optical signals required for thickness measurement may be further comprised. In the description, a terahertz signal transmitted through the measurement target 20 is received and the thickness is calculated using a transmission spectrum, but a terahertz signal reflected from the measurement target 20 may be received through a receiver setting as in FIG. 3, and the thickness is calculated using a reflection spectrum.

Devices outputting optical signals used for terahertz frequency generation may be referred to as source lasers. That is, the comb line extractor 110 outputting a frequency-fixed optical signal may be referred to as a first source laser, and the frequency-swept laser 200 outputting a frequency-swept optical signal, may be referred to as a second source laser. A laser outputting an optical frequency comb may be referred to as a reference laser.

The terahertz emitting-photomixer 300 and the terahertz receiving-photomixer 310 may each be referred to simply as a first photomixer and a second photomixer, or a terahertz emitter and a terahertz receiver, respectively.

In the description, devices have been distinguished to clarify their respective functions, but devices may be integrated, or one device may be implemented by being divided into multiple devices. In particular, DAQ 600 and the computing device 900 have been distinguished, but these do not necessarily need to be implemented physically separately.

First, terahertz signal generation of the terahertz spectrometer 10 is described.

The femtosecond laser 100 is a source laser outputting an optical frequency comb and may be implemented as a pulsed laser that generates a pulse train in the time domain. The femtosecond laser 100 may be an erbium-doped fiber femtosecond laser and may be stabilized by being locked to a frequency reference source 40. The frequency reference source 40 may be various such as an atomic clock, an optical clock, and the like.

When the pulse train emitted from the femtosecond laser 100 is viewed in a frequency domain, a discontinuous spectrum with a constant frequency interval (repetition rate) is observed, and such a discontinuous spectrum is referred to as an optical frequency comb. A single comb line constituting the optical frequency comb may be expressed as an integer multiple of the repetition rate. An n-th comb line of the optical frequency comb may be referred to as an n-th frequency mode. For example, the n-th comb line may be expressed as an integer multiple (n=1, 2, 3, . . . ) of a carrier envelope offset f_{ceo} and the repetition rate fᵣₑₚ, as in Equation 3.

v=nfᵣₑₚ+f_{ceo} (Equation 3)

The comb line extractor 110 outputs an optical signal corresponding to a fixed frequency v₁ used for terahertz frequency generation from an optical frequency comb. For example, the frequency v₁ may be a frequency of a comb line corresponding to a wavelength of 1565 nm. Since the carrier envelope offset f_{ceo} and repetition rate fᵣₑₚ that define the comb line are locked to the frequency reference source 40, the comb line extractor 110 may output an accurate and stable fixed frequency v₁.

The comb line extractor 110 may be composed of optical components that extract and amplify a single comb line through injection locking. There are various methods for extracting a comb line of frequency v₁ from an optical frequency comb. For example, the comb line extractor 110 may be composed of an optical filter that separates a comb line of a specified frequency from an adjacent spectrum, a laser diode (LD) that outputs a fixed frequency, and the like. The optical filter may be implemented, for example, by combining a fiber Fabry-Pérot (FFP) filter and a fiber Bragg grating (FBG) filter. The filtered comb line may be extracted by injection locking into a distributed feedback laser diode (DFB LD) for power amplification.

The AOM 120 may modulate the fixed frequency v₁ through frequency shift for an input optical signal. Thus, a modulation frequency by the frequency shift in the AOM 120 may be defined as a heterodyne frequency fₕ. The heterodyne frequency fₕ is introduced to enable fast and precise measurement of amplitude/phase spectra in the terahertz region.

Meanwhile, the frequency-swept laser 200 outputs an optical signal corresponding to a sweep frequency v₂(t) used for terahertz frequency generation. The frequency-swept laser 200 sweeps a certain frequency/wavelength range over time, for example, may be implemented to sweep a wavelength band from 1564 nm to 1540 nm. A sweep rate of the frequency-swept laser 200 may be calibrated through interference with an optical frequency comb.

The frequency-swept optical signal and the frequency-fixed optical signal modulated by the AOM 120, are optically combined by the OC 400 and output as an optical beat signal.

The terahertz emitting-photomixer 300 may output a terahertz signal sweeping in a certain band by performing optic-to-terahertz conversion on an optical beat signal. A terahertz frequency is a frequency of an optical beat signal generated by combining two optical signals, and may be defined as a difference (beatnote) between a fixed frequency and a sweep frequency. The terahertz emitting-photomixer 300 may focus the terahertz signal on a measurement target 20 through a parabolic mirror and induce a transmitted terahertz signal to the terahertz receiving-photomixer 310. For example, a terahertz signal sweeping 0.1-2.5 THz at a sweep rate of 10 THz/s or more may be generated through photomixing of an optical signal of a 1565 nm wavelength and an optical signal sweeping a wavelength band from 1564 nm to 1540 nm. A terahertz signal may interact with a single-layer measurement target 20 such as a semiconductor wafer or a secondary battery electrode coating to generate Fabry-Pérot interference fringes.

The terahertz receiving-photomixer 310 receives a terahertz signal transmitted through the measurement target 20 (or reflected from the measurement target 20). Simultaneously, the terahertz receiving-photomixer 310 is configured to receive an optical beat signal in which a frequency-fixed optical signal output from the comb line extractor 110 and the frequency-swept optical signal output from the frequency-swept laser 200 are combined. The terahertz receiving-photomixer 310 generates a beat signal by photomixing the received terahertz signal and the input optical beat signal. That is, precise terahertz spectrum measurement becomes possible through mixing of a terahertz signal with another optical beat signal other than the optical beat signal used for the terahertz signal generation.

The beat signal generated in the terahertz receiving-photomixer 310 is monitored in the TIA 700. The received terahertz signal was generated by photomixing of a frequency-swept optical signal and a frequency-fixed optical signal modulated by a heterodyne frequency fₕ by the AOM 120. Accordingly, the TIA 700, which is configured to amplify a photocurrent output from the terahertz receiving-photomixer 310 into a voltage signal and output the voltage signal, is configured to monitor a signal corresponding to a heterodyne frequency.

The LIA 800 extracts and amplifies a component identical to a reference (heterodyne frequency) provided by a voltage-controlled oscillator (VCO) from an output signal of the TIA 700. The LIA 800 may extract only the heterodyne frequency signal, which is a frequency of interest, from noise with very high precision.

The DAQ 600 may generate a transmission amplitude spectrum according to a terahertz frequency by sampling an output of the LIA 800, which is noise-removed heterodyne frequency signal intensity, and mapping it to the corresponding terahertz frequency.

By analyzing the transmission amplitude spectrum according to a terahertz frequency, an absolute frequency fₘ of an FP mode is determined, and a thickness t of a measurement target 20 may be calculated from the absolute frequency fₘ of the FP mode using Equation 2. When an approximate thickness range of a measurement target is known, an FP mode number m may be predetermined. The FP mode used for thickness measurement may be referred to as an FP mode of interest.

Thickness calculation may be performed by the DAQ 600 or a computing device 900 interworking with the DAQ 600. Since the terahertz spectrometer 10 is configured to provide high resolution and stability, an accurate FP mode position may be identified from interference fringes generated from the terahertz signal, and consequently, the absolute frequency of the FP mode may be simply converted into a thickness.

The transmission amplitude spectrum comprises several FP modes having a form of a peak or a dip at specific frequencies, and since the thickness is calculated from a frequency of an FP mode, precise absolute frequency measurement is required. To achieve this, by minimizing an influence of noise through spectrum fitting for measurement data around an FP mode, an absolute frequency (center frequency) of the corresponding FP mode may be precisely determined. Spectrum fitting for determining a center frequency of an FP mode may use various methods such as Lorentzian fitting, Gaussian fitting, Voigt profile fitting, Polynomial fitting, a Centroid method (Method of moments), and the like.

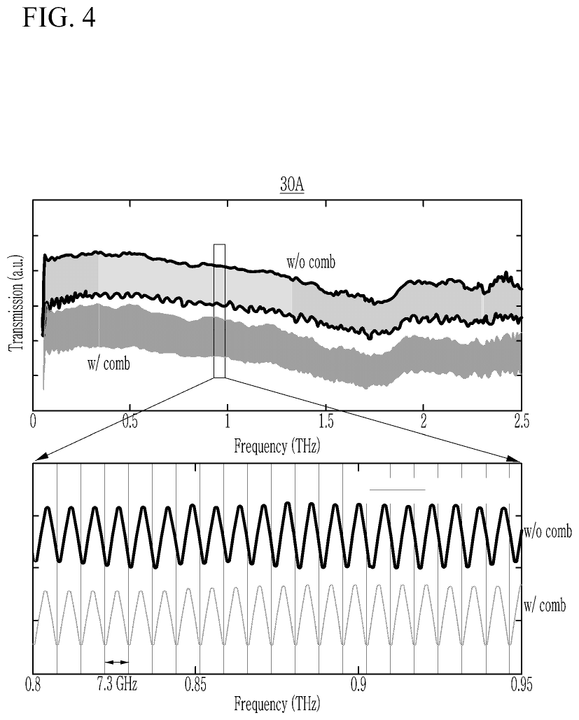

FIG. 4 is a result of comparing transmission amplitude spectra that vary according to presence or absence of optical frequency comb-based frequency calibration.

Referring to FIG. 4, a transmission amplitude spectrum 30A is a result of measuring FP interference of a high-resistivity float-zone (HRFZ) silicon wafer known to generate periodic FP interference fringes. The transmission amplitude spectrum 30A was derived as an average value of 1,000 traces collected at a high sweep rate of about 13 THz/s. It may be confirmed that the terahertz spectrometer 10 of the present disclosure may measure dense FP modes in a wide range of 2.5 THz with high precision.

By enlarging a spectrum around 0.9 THz in the transmission amplitude spectrum 30A, measurement data and a theoretical FP mode (vertical line) may be compared. Here, an FSR of an FP mode was calculated to be ~7.3 GHZ based on a refractive index of 3.416.

Looking at the results measured without optical frequency comb-based frequency calibration (w/o comb), unlike reality, since a constant linear sweep rate is assumed during frequency sweep, it may be confirmed that the theoretical FP mode and interference fringes are misaligned.

On the other hand, looking at the results measured with the terahertz spectrometer 10 of the present disclosure performing optical frequency comb-based frequency calibration (w/comb), it may be confirmed that nonlinear sweep rate variations are effectively calibrated, accurately resolving FP modes with a precision of less than 10 MHz. Since it is possible to accurately resolve FP modes in this manner, it is possible to directly measure thickness from the FP mode.

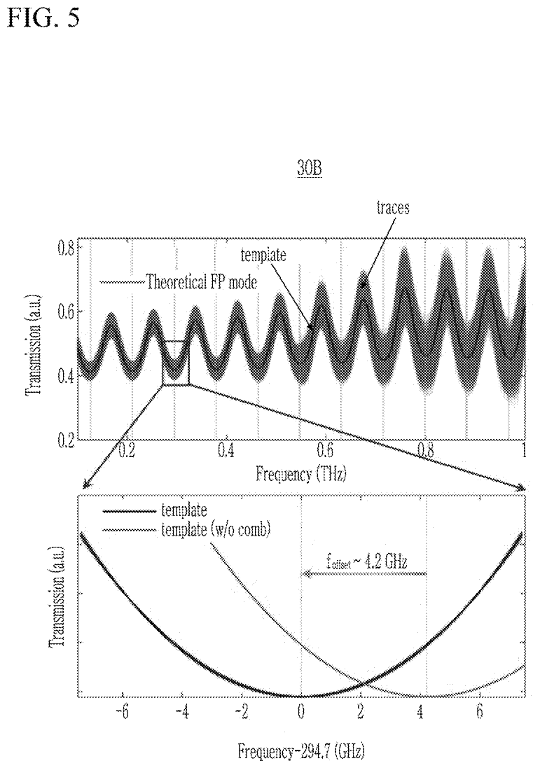

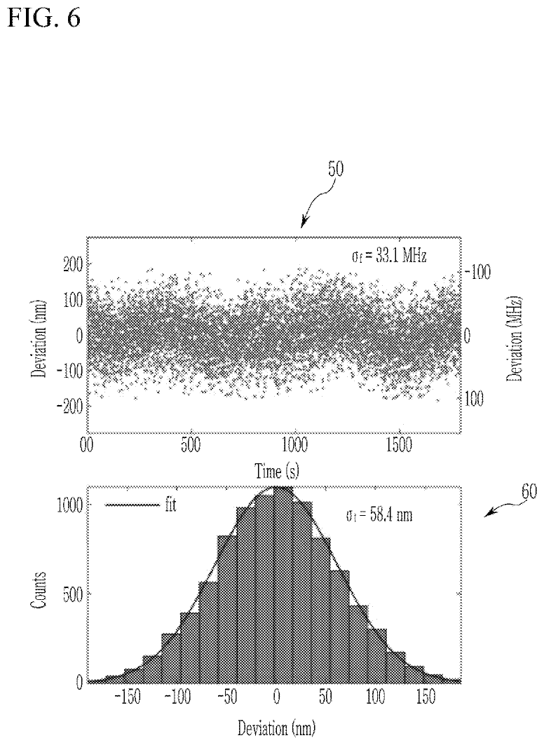

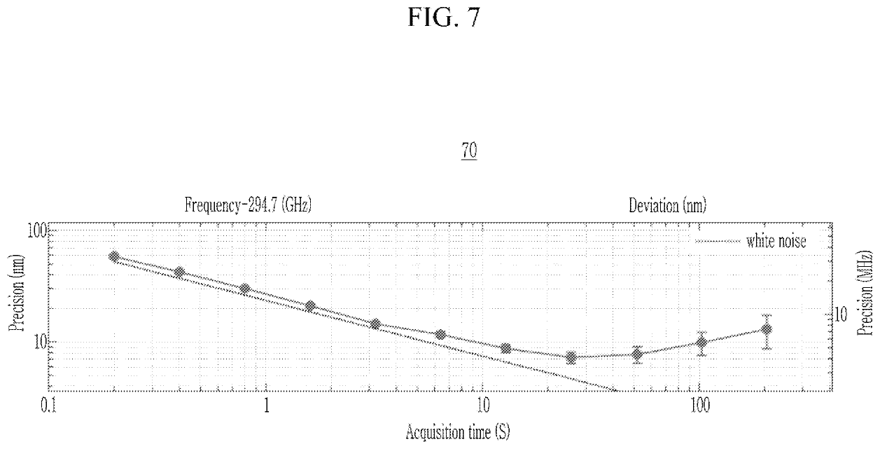

FIG. 5 is an example of a transmission amplitude spectrum according to an embodiment, FIG. 6 is a diagram showing a dispersion of a specific Fabry-Pérot mode and a histogram of an extracted thickness according to an embodiment, and FIG. 7 is a diagram showing an Allan deviation of a measured thickness according to an embodiment.

Referring to FIG. 5, to demonstrate nanometer-level precision and resistance to surface roughness, a thickness of an optically opaque single-side polished (SSP) p-type doped silicon wafer was measured. The wafer has a precisely polished surface and a roughly polished surface. Despite optical opacity due to surface scattering, a terahertz signal penetrates the surface to generate clear FP interference fringes, which shows robustness against surface scattering.

A transmission amplitude spectrum 30B is a transmission spectrum of a 525 um thick SSP silicon wafer, and measured FP mode positions coincide with theoretical FP modes (vertical lines). Measurement data represent all 9,000 traces collected for 30 minutes, each trace set at a 0.2-second cycle. FP modes corresponding to 10 constructive and 11 destructive interferences are observed in 0.1-1 THz range with an FSR of 83.6 GHZ. The increase in amplitude fluctuations at high frequencies is due to a low SNR of a terahertz source at high frequencies.

The precision of an FP mode position and thickness measurement may be analyzed by comparing an individual trace with a template generated from an average value of all traces. In the transmission amplitude spectrum 30B, traces around fₘ=3.5 (294.7 GHZ) and the template may be normalized to the same average amplitude. Comparing a template measured through optical frequency comb-based frequency calibration (referred to as “template”) and a template measured without optical frequency comb-based frequency calibration (referred to as “template (w/o comb)”), a center frequency offset between the two templates is approximately 4.2 GHz, which corresponds to a thickness error of about 7.5 μm. It may be confirmed that this offset is successfully calibrated through optical frequency comb-based frequency calibration.

A frequency deviation 50 may be determined through cross-correlation between a spectrum of each trace and an average spectrum. An effective line center shift of each trace may be determined by identifying a frequency shift that maximizes cross-correlation between a trace and a template. Cross-correlation is a method of determining how much individual data shifted along a frequency axis relative to a template, and a point where a correlation coefficient calculated while incrementally shifting the frequency axis becomes maximum may be set as an initial position for spectrum fitting.

A center frequency obtained by applying spectrum fitting to traces (measurement data) around each FP mode is determined as an absolute frequency of the corresponding FP mode. The thickness is calculated from the center frequency of the FP mode determined using the frequency-thickness conversion relationship in Equation 2.

Looking at the histogram 60 of thickness deviation in FIG. 6, it shows a Gaussian distribution, which indicates that random noise is a primary source of error, and suggests that precision may be improved by increasing acquisition time.

Referring to FIG. 7, looking at measurement precision 70 through Allan deviation applying various averaging times, a single data acquisition time is 0.2 seconds, providing a thickness precision of 58.4 nm and a frequency precision of 33.1 MHz. As acquisition time increases, measurement precision is improved due to an averaging effect, reaching a precision level of less than 10 nm at 7.8 seconds and less than 10 MHz at 2.6 seconds. The best precision of 7.2 nm and 4.1 MHz is achieved at an acquisition time of 25.6 seconds.

Also, an acquisition time t is proportional to a bandwidth Δv, and this relationship is expressed as τ=2Δv/vₛ, where vₛ is a sweep rate. Therefore, targeting a narrower bandwidth may significantly increase measurement speed. For example, reducing Δv from 1 THz to 0.1 THz increases the acquisition speed by 10 times.

Thus, the terahertz spectrometer 10 of the present disclosure may perform in-line or real-time monitoring in semiconductor processes such as wafer thinning by combining high precision, high speed, and high resistance to surface roughness.

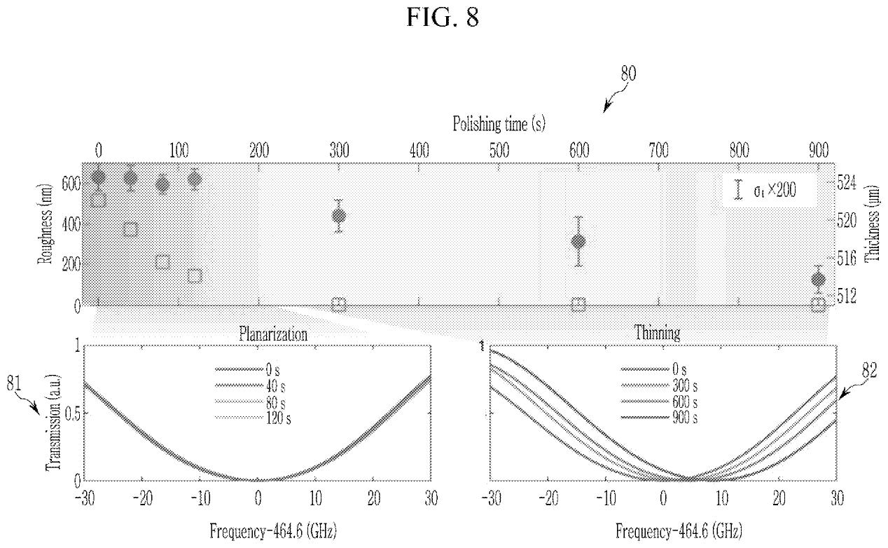

FIG. 8 is a diagram explaining a thickness measurement result not affected by surface roughness according to an embodiment.

Referring to FIG. 8, to demonstrate process monitoring capability, wafer samples with controlled surface roughness and thickness were acquired by performing chemical mechanical polishing (CMP) at a nominal pressure of 52.4 kPa, head and pad rotation speeds of 30 rpm, and a slurry flow rate of 100 mL/min.

Measurement results 80 of surface roughness (gray squares) and thickness (blue circles) according to polishing time are results measured by an atomic force microscope (AFM) and a terahertz FP interferometer, respectively, for comparative analysis. For clarity, blue error bars enlarged by 200 times represent thickness precision expressed as Allan deviation based on a 25.6-second acquisition time, and demonstrate nanometer-level precision regardless of surface roughness.

A left gray region of the measurement results 80 is a planarization process stage, and thickness remains almost constant while surface roughness starts at about 500 nm and decreases to about 100 nm. Consistent with this observation, a transmission amplitude spectrum 81 shows a transmission spectrum around fₘ=5.5 (464.6 GHz) measured during a planarization process. As roughness decreases while thickness variation is minimized, an FP mode shows only negligible frequency variations and maintains consistency within a range of <1 GHz.

To achieve a thickness reduction of several micrometers, head and pad rotation speeds were increased 3 times (90 rpm) in a wafer thinning process. A right blue region of the measurement results 80 represents a thinning process, where surface roughness improvement saturates at a sub-nanometer level and thickness becomes a primary control variable. When polishing time is increased to 300, 600, and 900 seconds, thickness reduction of about 4.1, 6.8, and 10.8 μm relative to an initial thickness occurs, respectively.

Transmission amplitude spectrum 82 shows a transmission spectrum around fₘ=5.5 (464.6 GHZ) measured during a thinning process. It shows that a frequency of an FP mode shifts toward a high-frequency direction according to thickness reduction. Shift amounts are 2.5, 4.9, and 8.5 GHZ, respectively, following the relationship given in Equation 1. While a conventional pulsed THz-TDS system with a typical spectral resolution of several GHz cannot resolve such subtle frequency variations, the terahertz spectrometer 10 of the present disclosure may resolve such subtle frequency variations.

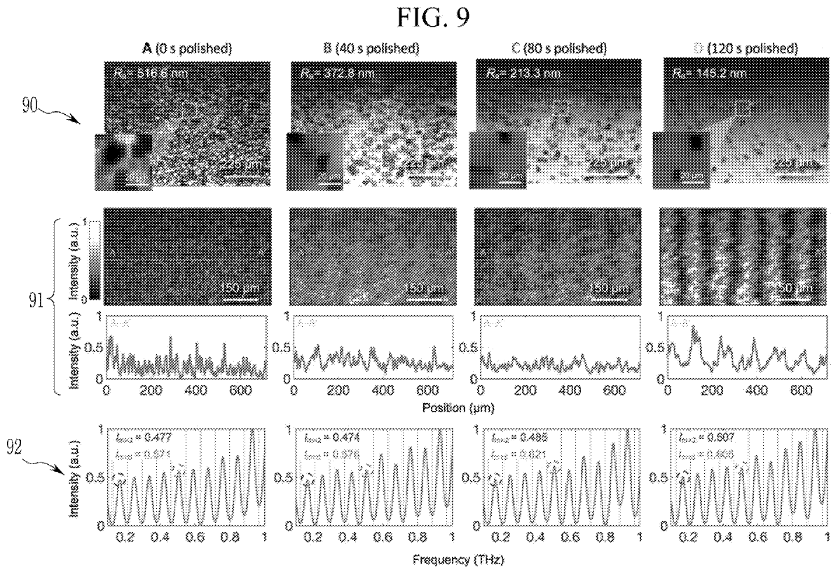

FIG. 9 is a diagram comparing measurement results of the present disclosure and a visible light laser-based Michelson interferometer.

Referring to FIG. 9, top images 90 are results of surface profile imaging captured with a sample-view camera integrated into an AFM system, and an inset image is an AFM image. Four silicon wafer samples A, B, C, and D with different surface roughness, obtained by adjusting polishing time during a CMP process, are used for measurements.

Middle images 91 show results of surface profile imaging measured using a visible light laser-based Michelson interferometer for silicon wafer samples A, B, C, and D, and an intensity profile measured along a center horizontal line (A-A′). Due to low transmittance of a visible spectrum through a silicon wafer, observed interference fringes are formed by interference between a wafer surface and a reference mirror. In wafers with roughness of 200 nm or more (samples A-C), fringe visibility is significantly degraded due to surface scattering. Even when roughness is improved (sample D), visibility only slightly improves due to residual scattering.

Bottom images 92 show transmission amplitude spectra obtained with the terahertz spectrometer 10 of the present disclosure and theoretical positions (vertical lines) of FP modes for silicon wafer samples A, B, C, and D. Transmission amplitude spectra show excellent visibility regardless of surface roughness, and demonstrate roughness insensitivity of terahertz measurement. Vertical lines indicated in the transmission amplitude spectra represent theoretical positions of FP modes, and show negligible frequency shifts compared to measured FP mode positions (peaks, dips). This demonstrates effectiveness of the present disclosure in suppressing surface scattering and maintaining measurement precision during a planarization process. In particular, an FP interferometer has inherent robustness against various environmental disturbances due to a common path configuration, and is very suitable for high-precision process monitoring under general environmental conditions.

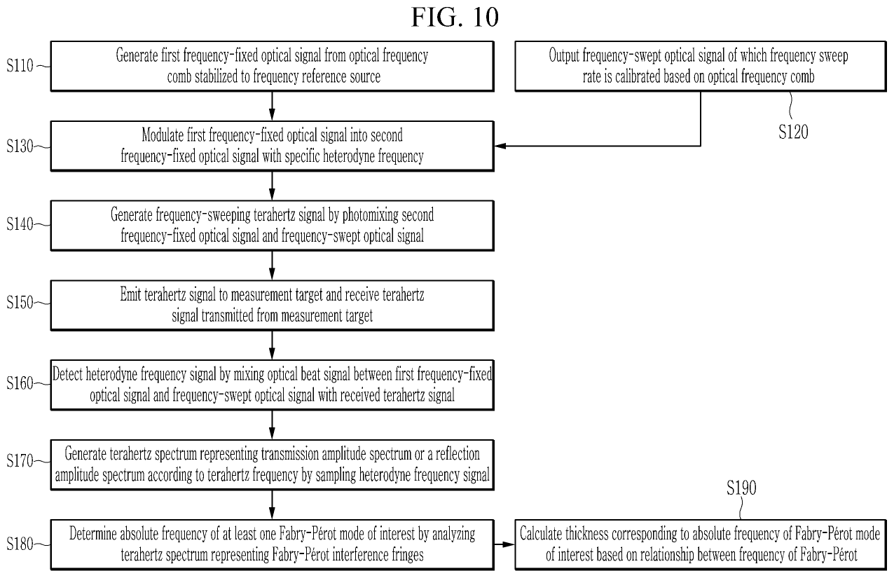

FIG. 10 is a flowchart of a thickness measurement method according to an embodiment.

Referring to FIG. 10, the terahertz spectrometer 10 generates a first frequency-fixed optical signal from an optical frequency comb stabilized to a frequency reference source (S110).

The terahertz spectrometer 10 outputs a frequency-swept optical signal of which a frequency sweep rate is calibrated based on an optical frequency comb (S120). The terahertz spectrometer 10 may be configured to perform frequency calibration by interfering a frequency-swept laser output and an optical frequency comb acting as a precise wavelength meter. Since a frequency sweep is performed at a nonlinear sweep rate rather than a linear sweep rate in reality, precision of a terahertz signal generated from a frequency-swept optical signal may be improved by calibrating a nonlinear sweep rate using an optical frequency comb.

The terahertz spectrometer 10 modulates a first frequency-fixed optical signal into a second frequency-fixed optical signal with a specific heterodyne frequency (S130).

The terahertz spectrometer 10 generates a frequency-sweeping terahertz signal by photomixing the second frequency-fixed optical signal and the frequency-swept optical signal (S140).

The terahertz spectrometer 10 emits the terahertz signal to a measurement target, and receives the terahertz signal transmitted from the measurement target (S150). The terahertz signal generates Fabry-Pérot interference fringes by multiple internal reflections in a measurement target. The received terahertz signal may be a signal transmitted through a measurement target or a signal reflected from a measurement target.

The terahertz spectrometer 10 detects a heterodyne frequency signal by mixing an optical beat signal between the first frequency-fixed optical signal and the frequency-swept optical signal with a received terahertz signal (S160).

The terahertz spectrometer 10 generates a terahertz spectrum representing a transmission amplitude spectrum or a reflection amplitude spectrum according to the terahertz frequency by sampling a heterodyne frequency signal (S170). The transmission/reflection amplitude spectrum comprises several FP modes having a form of a peak or a dip at specific frequencies.

The terahertz spectrometer 10 determines an absolute frequency of at least one Fabry-Pérot mode of interest by analyzing a terahertz spectrum representing Fabry-Pérot interference fringes (S180). The terahertz spectrometer 10 may determine an absolute frequency of an FP mode by applying spectrum fitting to measurement data around the FP mode in a terahertz spectrum. At this time, a line center shift may be identified through cross-correlation between a spectrum of individual measurement data (trace) and an average spectrum, so that measurement data around an FP mode to which spectrum fitting is to be applied may be quickly determined, and a more accurate absolute frequency may be determined by increasing measurement time.

The terahertz spectrometer 10 calculates a thickness corresponding to an absolute frequency of a Fabry-Perot mode of interest based on a relationship between a frequency of a Fabry-Pérot mode and thickness (S190).

As described above, according to the present disclosure, the limitations of conventional thickness measurement methods may be overcome by utilizing terahertz frequencies that offer superior transmittance of wafers compared to visible light and near-infrared light and minimize scattering effects caused by surface roughness.

According to the present disclosure, the precision of semiconductor wafer thickness measurement may be improved to the nanometer level, thickness measurements may be performed reliably regardless of surface conditions such as surface roughness, and measurements can be completed quickly within several seconds.

According to the present disclosure, by directly measuring an absolute frequency of the Fabry-Pérot mode caused by Fabry-Pérot interference, measurement accuracy may be improved while ensuring frequency stability. Furthermore, by eliminating a necessity for interference fringes analysis across a broadband spectrum, faster measurements may be performed in a narrower spectral range.

According to the present disclosure, a fixed frequency may be obtained by extracting a comb line from an optical frequency comb locked to a frequency standard, and an absolutely calibrated optical frequency may be generated through the optical frequency comb-based sweep frequency calibration, thereby enabling the generation of a stable terahertz frequency.

According to the present disclosure, the reliability and performance of semiconductor processes may be ensured through real-time thickness measurement.

The present disclosure may be utilized for implementing an in-line monitoring and control platform for end-point detection, early defect detection, and process optimization during the silicon wafer thinning process.

The present disclosure may be applied to various semiconductor processes such as TSV (Through-Silicon Via) formation, nanomaterial stacking, and thin-film transistor fabrication, to monitor wafer thickness in real-time. Accordingly, the reliability of semiconductor manufacturing processes may be increased by maintaining optimal process conditions and improving product quality. The present disclosure may be utilized as a core technology for next-generation semiconductor manufacturing processes.

The embodiments of the present invention described above are not only implemented through apparatuses and methods, but may also be implemented through a program realizing functions corresponding to configurations of the embodiments of the present invention or a recording medium on which the program is recorded.

While embodiments of the present invention have been described in detail above, the scope of rights of the present invention is not limited thereto, and various modifications and improvements of those skilled in the art using basic concepts of the present invention defined in the following claims are also within the scope of rights of the present invention.

What is claimed is:

1. A terahertz spectrometer, comprising:
a comb line extractor configured to extract a comb line from an optical frequency comb and output a frequency-fixed optical signal;
a frequency-swept laser configured to output a frequency-swept optical signal that is frequency-calibrated based on the optical frequency comb;
a terahertz emitting-photomixer configured to generate a frequency-sweeping terahertz signal by photomixing the frequency-swept optical signal with the frequency-fixed optical signal modulated with a heterodyne frequency, and to emit the terahertz signal to a measurement target;
a terahertz receiving-photomixer configured to receive the terahertz signal transmitted from the measurement target and to mix an optical beat signal with the received terahertz signal, the optical beat signal generated by combination of the frequency-fixed optical signal and the frequency-swept optical signal; and
a thickness measurement module configured to generate a terahertz spectrum from an output of the terahertz receiving-photomixer, analyze the terahertz spectrum to determine an absolute frequency of a Fabry-Pérot mode, and calculate a thickness from the absolute frequency.

2. The terahertz spectrometer of claim 1, wherein a nonlinear sweep rate of the optical signal output from the frequency-swept laser is calibrated through interference with the optical frequency comb.

3. The terahertz spectrometer of claim 1, wherein the optical frequency comb is stabilized by being locked to a frequency reference source.

4. The terahertz spectrometer of claim 1, wherein the terahertz spectrum comprises Fabry-Pérot modes having a form of a peak or a dip at specific frequencies.

5. The terahertz spectrometer of claim 1, further comprising
an acousto-optic modulator configured to perform modulation to frequency-shift the frequency-fixed optical signal output from the comb line extractor by the heterodyne frequency.

6. The terahertz spectrometer of claim 1, wherein the terahertz receiving-photomixer is configured to output a signal corresponding to the heterodyne frequency by mixing the optical beat signal with the received terahertz signal.

7. The terahertz spectrometer of claim 6, wherein the thickness measurement module comprises:
a transimpedance amplifier configured to amplify the output of the terahertz receiving-photomixer into a voltage signal and output the voltage signal;
a lock-in amplifier configured to extract and amplify a component identical to the heterodyne frequency from the output of the transimpedance amplifier;
a data acquisition device configured to generate the terahertz spectrum representing a transmission amplitude or a reflection amplitude according to the terahertz frequency by sampling an output of the lock-in amplifier and mapping the sampled output to a corresponding terahertz frequency; and
a computing device configured to analyze the terahertz spectrum to determine the absolute frequency and calculate the thickness from the absolute frequency.

8. The terahertz spectrometer of claim 7, wherein the computing device is configured to determine the absolute frequency of a corresponding Fabry-Pérot mode by applying spectrum fitting to measurement data around the Fabry-Pérot mode in the terahertz spectrum.

9. A terahertz spectrometer, comprising:
a first photomixer configured to generate a frequency-sweeping terahertz signal through photomixing of a frequency-fixed optical signal generated based on an optical frequency comb and a frequency-swept optical signal that is frequency-calibrated based on the optical frequency comb, and to emit the terahertz signal to a measurement target;
a second photomixer configured to receive the terahertz signal transmitted from the measurement target and to mix an optical beat signal with the received terahertz signal; and
a thickness measurement module configured to generate a terahertz spectrum from an output of the second photomixer, analyze the terahertz spectrum to determine an absolute frequency of a Fabry-Pérot mode, and calculate a thickness from the absolute frequency.

10. The terahertz spectrometer of claim 9, wherein the frequency-fixed optical signal is optically combined with the frequency-swept optical signal after being modulated with a heterodyne frequency for terahertz signal generation, and the optical beat signal is generated by optical combination of the frequency-fixed optical signal and the frequency-swept optical signal.

11. The terahertz spectrometer of claim 10, wherein the thickness measurement module comprises:
a transimpedance amplifier configured to amplify the output of the second photomixer into a voltage signal and output the voltage signal;
a lock-in amplifier configured to extract and amplify a component identical to the heterodyne frequency from an output of the transimpedance amplifier;
a data acquisition device configured to generate the terahertz spectrum representing a transmission amplitude or a reflection amplitude according to the terahertz frequency by sampling an output of the lock-in amplifier and mapping the sampled output to a corresponding terahertz frequency; and
a computing device configured to analyze the terahertz spectrum to determine the absolute frequency and calculate the thickness from the absolute frequency.

12. The terahertz spectrometer of claim 11, wherein the computing device is configured to determine the absolute frequency of a corresponding Fabry-Pérot mode by applying spectrum fitting to measurement data around the Fabry-Pérot mode in the terahertz spectrum.

13. The terahertz spectrometer of claim 9, wherein a nonlinear sweep rate of the frequency-swept optical signal is calibrated through interference with the optical frequency comb.

14. The terahertz spectrometer of claim 9, wherein the optical frequency comb is stabilized by being locked to a frequency reference source.

15. The terahertz spectrometer of claim 9, wherein the terahertz spectrum comprises Fabry-Pérot modes having a form of a peak or a dip at specific frequencies.

16. A thickness measurement method of an optical frequency comb-based terahertz spectrometer, comprising:
generating a frequency-sweeping terahertz signal using a first frequency-fixed optical signal generated based on an optical frequency comb and a frequency-swept optical signal frequency-calibrated based on the optical frequency comb;
emitting the terahertz signal to a measurement target and receiving the terahertz signal transmitted from the measurement target;
generating a terahertz spectrum comprising Fabry-Pérot modes having a form of a peak or a dip at specific frequencies based on the received terahertz signal; and
analyzing the terahertz spectrum to determine an absolute frequency of at least one Fabry-Pérot mode of interest, and calculating a thickness from the absolute frequency.

17. The thickness measurement method of claim 16, wherein the generating the frequency-sweeping terahertz signal comprises:
generating the first frequency-fixed optical signal from the optical frequency comb stabilized to a frequency reference source;
outputting the frequency-swept optical signal whose frequency sweep rate is calibrated based on the optical frequency comb;
modulating the first frequency-fixed optical signal into a second frequency-fixed optical signal with a specific heterodyne frequency; and
generating the frequency-sweeping terahertz signal by photomixing the second frequency-fixed optical signal and the frequency-swept optical signal.

18. The thickness measurement method of claim 17, wherein the generating the terahertz spectrum comprises:
detecting a heterodyne frequency signal by mixing a beat signal between the first frequency-fixed optical signal and the frequency-swept optical signal with the received terahertz signal; and
generating the terahertz spectrum representing a transmission amplitude spectrum or a reflection amplitude spectrum according to the terahertz frequency by sampling the heterodyne frequency signal.

19. The thickness measurement method of claim 18, wherein the calculating the thickness comprises:
determining the absolute frequency of a corresponding Fabry-Pérot mode by applying spectrum fitting to measurement data around the Fabry-Pérot mode in the terahertz spectrum; and
calculating the thickness of the measurement target from the absolute frequency based on a relationship between a frequency of a Fabry-Pérot mode and thickness.

20. The thickness measurement method of claim 16, wherein the optical frequency comb is stabilized by being locked to a frequency reference source, and
a nonlinear sweep rate of the frequency-swept optical signal is calibrated through interference with the optical frequency comb.
